(19) United States
(12) Patent Application Publication
(10) Pub. No.: US 2021/0049985 A1
(43) Pub. Date: Feb. 18, 2021

(54) IMAGE CONTROL APPARATUS, DISPLAY APPARATUS, MOBILE BODY, IMAGE DATA GENERATION METHOD, AND RECORDING MEDIUM

(71) Applicants: Masato KUSANAGI, Kanagawa (JP); Kenichiroh SAISHO, Tokyo (JP); Hiroshi YAMAGUCHI, Kanagawa (JP); Keita KATAGIRI, Kanagawa (JP); Yuuki SUZUKI, Kanagawa (JP)

(72) Inventors: Masato KUSANAGI, Kanagawa (JP); Kenichiroh SAISHO, Tokyo (JP); Hiroshi YAMAGUCHI, Kanagawa (JP); Keita KATAGIRI, Kanagawa (JP); Yuuki SUZUKI, Kanagawa (JP)

(21) Appl. No.: 16/979,699

(22) PCT Filed: Mar. 26, 2019
(86) PCT No.: PCT/JP2019/013029

§ 371 Date: Sep. 10, 2020

(30) Foreign Application Priority Data
Mar. 28, 2018 (JP) 2018-062094
Mar. 28, 2018 (JP) 2018-062096
Mar. 20, 2019 (JP) 2019-052964

(51) Int. Cl. G09G 5/38; G09G 5/14; G01C 21/36

(52) U.S. Cl. CPC G09G 5/38; G09G 5/14; G09G 2380/10; G09G 2340/0464; G01C 21/365

(57) ABSTRACT

An image control apparatus includes an image generator that generates image data for displaying information indicating a direction or a position in a display region on a mobile body. The image generator generates the image data such that, from a viewpoint of an occupant of the mobile body, information indicating a left-hand direction or a left-side position is displayed to the left of information indicating a right-hand direction or a right-side position, and a position where the information indicating the left-hand direction or the left-side position is displayed and a position where the information indicating the right-hand direction or the right-side position is displayed are arranged along the lateral direction of the display region.

### TECHNICAL FIELD

An aspect of this disclosure relates to an image control apparatus, a display apparatus, a mobile body, an image data generation method, and a program.

### BACKGROUND ART

There is a known head-up display (HUD) that provides information to an occupant in a mobile body (mobile machine) such as a vehicle, a ship, an airplane, or an industrial robot that moves and carries an occupant such as a driver. An HUD displays an image by causing image light to be reflected by a windshield or a combiner and enables an occupant to see information displayed in an image region of the displayed image. The occupant can also see a background such as a road surface through the displayed image.

There is also an HUD that provides a driver of a vehicle with information about a distance to a guidance point (see, for example, Patent Document 1).

### CITATION LIST

### Patent Literature

[PTL 1] Japanese Laid-Open Patent Publication No. 2013-079930

### SUMMARY OF INVENTION

### Technical Problem

However, with the related-art technologies described above, a user (e.g., a driver or a passenger) may feel bothered when the user obtains the information displayed in the image region of the displayed image or while the user is driving.

For example, when many information items such as a distance to a guidance point and a vehicle speed are randomly displayed in the image region, the user needs to find a desired information item from these information items and may feel bothered. As another example, if information is displayed near the central visual field of the driver in the image region of the displayed image, the driver may feel bothered while driving.

One object of an aspect of this disclosure is to prevent displayed information from bothering a user.

### Solution to Problem

According to an aspect of this disclosure, there is provided an image control apparatus including an image generator that generates image data for displaying information indicating a direction or a position in a display region on a mobile body. The image generator generates the image data such that, from a viewpoint of an occupant of the mobile body, information indicating a left-hand direction or a left-side position is displayed to the left of information indicating a right-hand direction or a right-side position, and a position where the information indicating the left-hand direction or the left-side position is displayed and a position where the information indicating the right-hand direction or the right-side position is displayed are arranged along the lateral direction of the display region.

### BRIEF DESCRIPTION OF DRAWINGS

FIG. 1A is a drawing illustrating an example of a configuration of a vehicle including a display apparatus according to an embodiment;

FIG. 1B is a drawing illustrating an example of an area onto which a display image is projected;

FIG. 1C is a drawing illustrating an example of a configuration of a display system of the vehicle including the display apparatus according to an embodiment;

FIG. 2 is a block diagram illustrating an example of a hardware configuration of the display apparatus according to an embodiment;

FIG. 3 is a block diagram illustrating an example of a functional configuration of the display apparatus according to a first embodiment;

FIG. 4 is a drawing illustrating an example of an area in an image area of a display image where display object information is displayed;

FIG. 5 is a flowchart illustrating a process performed by a display apparatus according to the first embodiment;

FIG. 6 is a drawing illustrating an example of a display image according to the first embodiment;

FIG. 7 is a drawing illustrating another example of a display image according to the first embodiment;

FIG. 8 is a flowchart illustrating a process performed by a display apparatus according to a second embodiment;

FIG. 9A is a drawing illustrating an example of a display image according to the second embodiment;

FIG. 9B is a drawing illustrating another example of a display image according to the second embodiment;

FIG. 10A is a drawing illustrating another example of a display image according to the second embodiment; and

FIG. 10B is a drawing illustrating another example of a display image according to the second embodiment.

### DESCRIPTION OF EMBODIMENTS

Embodiments of the present invention are described below with reference to the accompanying drawings. A display apparatus 10 is described in the embodiments below. The display apparatus 10 is provided in a mobile body and displays a display image for providing an occupant of the mobile body with various types of information (e.g., a distance to the next guidance point, a travel direction at the next guidance point, a name of the next guidance point, the current speed of the mobile body, and so on). In the descriptions below, it is assumed that the mobile body is a vehicle (four-wheeled vehicle), and the display apparatus 10 is an HUD.

However, the mobile body is not limited to a four-wheeled vehicle and may instead be a vehicle (e.g., a motorcycle or a motor tricycle) other than a four-wheeled vehicle, a railcar, a ship, an airplane, an industrial robot, a bicycle, a farm tractor, or a construction machine such as a shovel car or a truck crane. That is, the mobile body may be any mobile object that a person can ride.

Also, the display apparatus 10 is not limited to an HUD and may be, for example, a head mounted display (HMD). That is, the display apparatus 10 may be any apparatus that displays a display image for providing a user with various types of information. When a head mounted display is used as the display apparatus 10, the user may not necessarily be on a mobile body. In this case, the user may be, for example, a pedestrian.

<Configuration of Vehicle Including Display Apparatus>

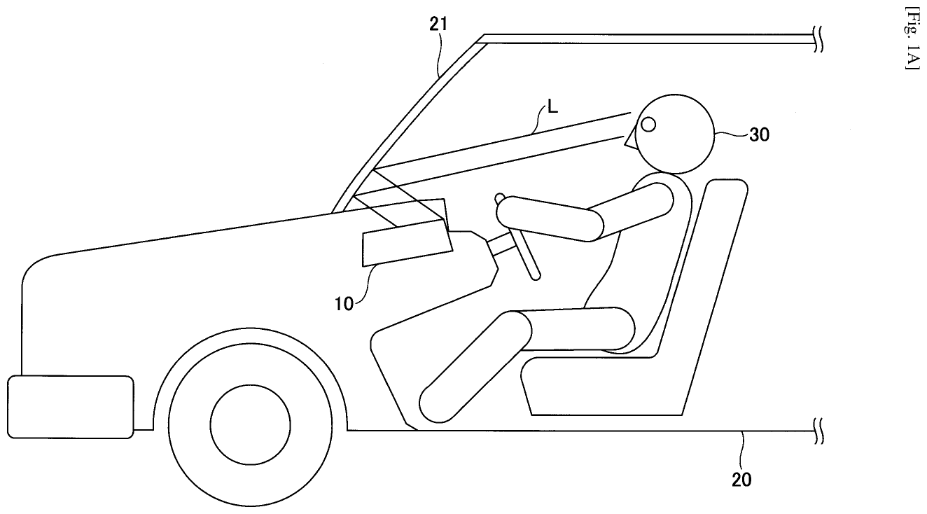

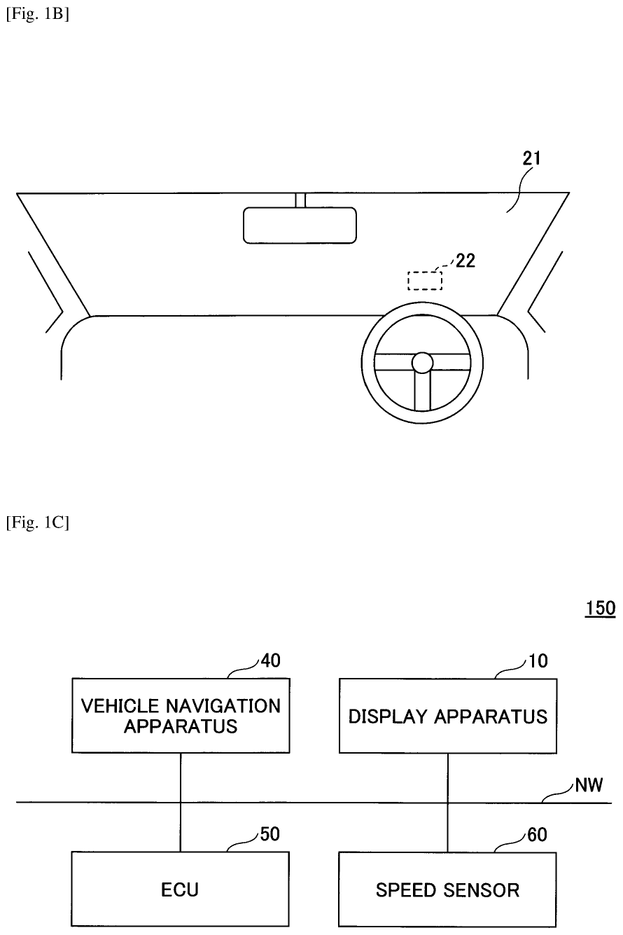

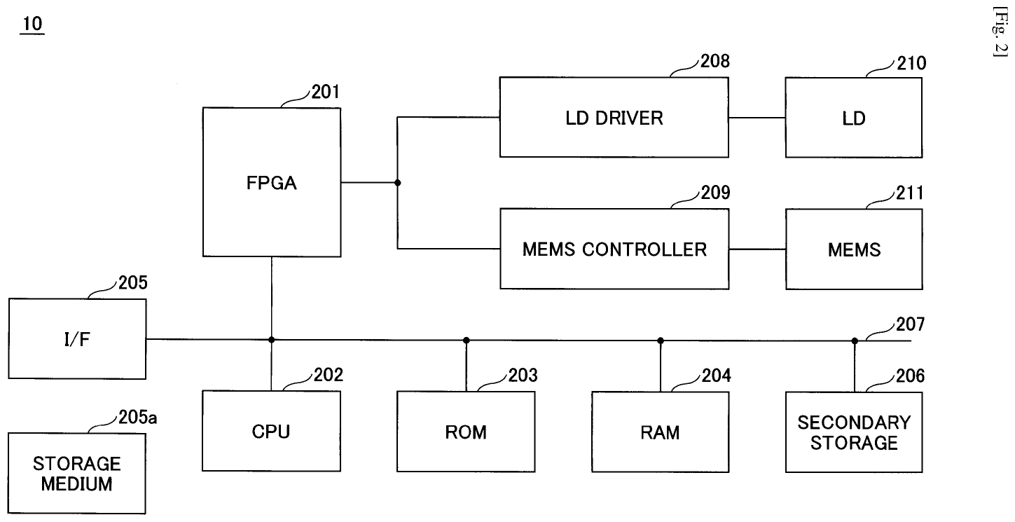

A configuration of a vehicle 20 including the display apparatus 10 according to an embodiment is described with reference to FIG. 1A. FIG. 1A is a drawing illustrating an example of a configuration of the vehicle 20 including the display apparatus 10. In the descriptions below, it is assumed that the display apparatus 10 projects a display image where various types of information are viewed as virtual images.

As illustrated in FIG. 1A, the display apparatus 10 is disposed in, for example, a dashboard of the vehicle 20. The display apparatus 10 includes an optical device (not shown). The optical device forms an optical image based on image data. Also, the optical device projects display image light, which is the formed optical image, onto a projection region 22 of the windshield 21. The windshield 21 is formed of a transmissive reflective material (transmissive reflector) that transmits a portion of light and reflects another portion of the light. The formed optical image is projected by a projection optical system included in the optical device and is reflected by the windshield 21 toward an occupant 30 who is a viewer. As a result, as illustrated in FIG. 1B, the occupant 30 can view a display image in the projection region 22 of the windshield 21.

Because the occupant 30 views information items displayed by the display image as virtual images, the occupant 30 can superpose the information items on an environment (e.g., a road surface, a leading vehicle, etc.) outside of the vehicle 20. Here, a transmissive reflector is a component or a material that can transmit a part of light and reflect another part of the light.

<Configuration of Display System of Vehicle>

A configuration of a display system 150 of the vehicle 20 is described with reference to FIG. 1C. FIG. 1C is a drawing illustrating an example of a configuration of the display system 150 of the vehicle 20.

As illustrated in FIG. 1C, the display system 150 includes the display apparatus 10, a vehicle navigation apparatus 40, an electronic control unit (ECU) 50, and a speed sensor 60 that are connected to and can communicate with each other via an in-vehicle network NW such as a controller area network (CAN).

The vehicle navigation apparatus 40 includes a function that supports a Global Navigation Satellite System (GNSS) such as the Global Positioning System (GPS). The vehicle navigation apparatus 40 can detect the current position the vehicle 20 and display the current position on an electronic map. Also, the vehicle navigation apparatus 40 can receive inputs of a start point and a destination, search for a route from the start point to the destination, display the route on the electronic map, and provide the driver with guidance indicating a travel direction before a turn by using audio or characters or an animation displayed on a display. In other words, the vehicle navigation apparatus 40 is a computer that performs navigation (e.g., presentation of information such as a distance to the next guidance point and a travel direction at the guidance point) to a destination specified by the user. The vehicle navigation apparatus 40 may be configured to communicate with a server via, for example, a cell-phone network. In this case, the server may send an electronic map to the vehicle 20 and perform a route search.

The ECU 50 is a computer that controls various devices on the vehicle 20 such as an engine, a motor, a meter, an air conditioner, and sensors. The sensors may be disposed inside and outside of the vehicle 20 and may detect, for example, an outside temperature and outside objects (e.g., other vehicles and pedestrians).

The speed sensor 60, for example, detects rotations of a wheel using a Hall element and outputs a pulse wave corresponding to the rotation speed. Also, the speed sensor 60 detects the vehicle speed based on the number of rotations (or pulses) per unit time and the outside diameter of the tire.

The display apparatus 10 can obtain information from various sensors provided on the vehicle 20. Also, the display apparatus 10 may obtain information from an external network instead of or in addition to the in-vehicle network NW. For example, the display apparatus 10 may obtain car navigation information, a steering angle, and a vehicle speed from an external network.

<Hardware Configuration>

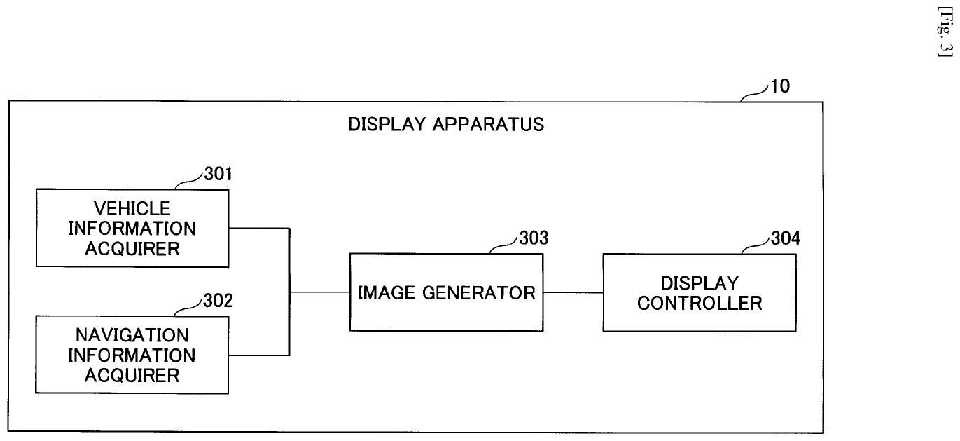

Next, a hardware configuration of the display apparatus 10 according to an embodiment is described. FIG. 2 is a block diagram illustrating an example of a hardware configuration of the display apparatus 10 according to an embodiment.

As illustrated in FIG. 2, the display apparatus 10 of the present embodiment includes a field programmable gate array (FPGA) 201, a central processing unit (CPU) 202, a read-only memory (ROM) 203, and a random access memory (RAM). The display apparatus 10 also includes an interface (I/F) 205, a secondary storage 206, a bus line 207, a laser diode (LD) driver 208, and a micro electro mechanical systems (MEMS) controller 209. The display apparatus 10 further includes an LD 210 and a MEMS 211. The FPGA 201, the CPU 202, the ROM 203, the RAM 204, the I/F 205, and the secondary storage 206 are connected to each other via the bus line 207.

The FPGA 201 controls operations of the LD 210 that is a light source. Also, the FPGA 201 controls, via the MEMS controller 209, operations of the MEMS 211 that is a light deflector.

The CPU 202 is a processor that loads programs and data from storage devices such as the ROM 203 and the secondary storage 206 into the RAM 204 and executes the loaded programs to control the display apparatus 10 and to implement various functional units of the display apparatus 10. The ROM 203 is a nonvolatile semiconductor memory storing programs to be executed by the CPU 202 to control functions of the display apparatus 10. The RAM 204 is a volatile semiconductor memory used as a work area for the CPU 202.

The I/F 205 is an interface for communications with external controllers. For example, the I/F 205 is connected via the in-vehicle network NW such as a CAN of the vehicle 20 to the ECU 50, the vehicle navigation apparatus 40, and various sensors such as the speed sensor 60.

Also, the display apparatus 10 can read and write data from and to a storage medium 205a via the I/F 205. Programs that cause the display apparatus 10 to perform various processes may be provided via the storage medium 205a. In this case, the programs are installed from the storage medium 205a via the I/F 205 into the secondary storage 206. The programs may also be downloaded via a network from another computer.

The secondary storage 206 stores programs, and files and data necessary for processes performed by the programs.

The storage medium 205a may be implemented by, for example, a flexible disk, a compact disk (CD) ROM, a digital versatile disk (DVD), a secure digital (SD) memory card, or a universal serial bus (USB) memory. The secondary storage 206 may be implemented by, for example, a hard disk drive (HDD) or a flash memory. The storage medium 205a and the secondary storage 206 are examples of non-transitory computer-readable storage media.

### First Embodiment

A first embodiment is described below.

<Functional Configuration>

First, a functional configuration of the display apparatus 10 according to the first embodiment is described with reference to FIG. 3. FIG. 3 is a block diagram illustrating an example of a functional configuration of the display apparatus 10 of the first embodiment.

As illustrated in FIG. 3, the display apparatus 10 includes a vehicle information acquirer 301, a navigation information acquirer 302, an image generator 303, and a display controller 304. These functional units may be implemented by executing one or more programs installed in the display apparatus 10 by the CPU 202. Also, the image generator 303 may be implemented by a collaboration between the CPU 202 and the FPGA 201 in FIG. 2. Further, the display controller 304 may be implemented by a collaboration of the CPU 202, the FPGA 201, the LD driver 208, and the MEMS controller 209.

The vehicle information acquirer 301 obtains information (which is hereafter referred to as “vehicle information) regarding the vehicle 20. The vehicle information is obtained from various sensors provided on the vehicle 20. For example, the vehicle information includes a speed, a travel distance, and a location of the vehicle 20, outside brightness, and information on pedestrians and other vehicles.

For example, the vehicle information acquirer 301 can obtain vehicle information from the ECU 50 of the vehicle 20 via the I/F 205.

The navigation information acquirer 302 obtains navigation information for the vehicle 20. The navigation information is obtained from the vehicle navigation apparatus 40 provided on the vehicle 20. For example, the navigation information includes a destination set by a user, a route to the destination, guidance points between a start point and the destination, a distance from a current position to the next guidance point, a travel direction at the next guidance point, the name of the next guidance point, and a speed limit on a currently-traveling road. Here, a guidance point indicates a point (e.g., a branching point such as an intersection or a Y-shaped branch) at which the travel direction of the vehicle 20 changes or a predetermined way point (e.g., a tollgate or an interchange).

For example, the navigation information acquirer 302 can obtain navigation information from the vehicle navigation apparatus 40 on the vehicle 20 via the I/F 205.

The navigation information acquirer 302 may also obtain navigation information from an information processing terminal having a navigation function. Examples of information processing terminals include a smartphone, a tablet PC, a personal computer (PC), a portable game machine, a personal digital assistant (PDA), and a wearable device. In this case, the navigation to a destination is performed by the information processing terminal.

The image generator 303 generates one or more sets of display object information based on at least one of the vehicle information (information regarding a mobile body) obtained by the vehicle information acquirer 301 and the navigation information obtained by the navigation information acquirer 302. Then, the image generator 303 generates a display image (image data) for displaying the display object information. The image generator 303 generates the display image such that the display object information is displayed in a predetermined region in an image region of the display image. For example, the predetermined region has an area that is less than or equal to one half of the area of the image region of the display image.

Here, the display object information is an object (or an icon) that indicates the vehicle information or the navigation information. For example, when obtained navigation information indicates a right turn at a guidance point, the image generator 303 generates an object (or an icon) indicating a right turn as the display object information. Similarly, when obtained navigation information indicates a speed limit of 80 km/h on a currently-traveling road, the image generator 303 generates an object (or an icon) indicating a speed limit of 80 km/h. Information items in the vehicle information and the navigation information used to generate display object information may be freely set by, for example, the user of the display apparatus 10.

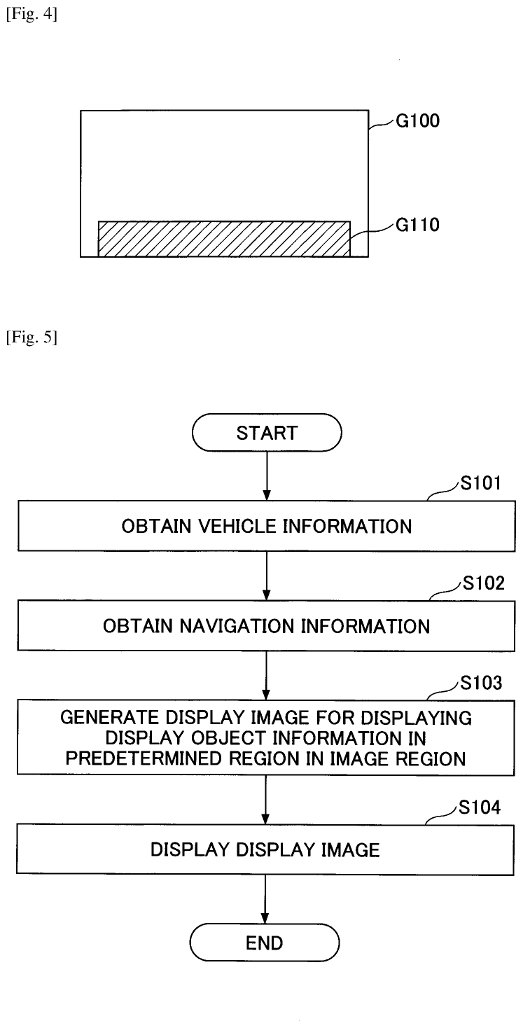

The image generator 303 generates the display image such that the display object information is displayed in a lower-end region with a predetermined height and a predetermined width in an image region of the display image. More specifically, as exemplified in FIG. 4, the image generator 303 generates the display image such that the display object information is displayed in a region G110 with a predetermined height and a predetermined width at the lower end of an image region G100 of the display image. In the example of FIG. 4, the width of the region G110 is less than the width of the image region G100. However, the width of the region G110 may be the same as the width of the image region G100.

Displaying the display object information in the region G110 results in displaying the display object information near the peripheral visual field of the user and makes it possible to prevent the displayed display object information from bothering the user. Also, because one or more sets of display object information are displayed together in the same region G110, the user can easily view desired information. The height of the region G110 in the vertical direction is preferably less than one half of the height of the image region G100 in the vertical direction, and the width of the region G110 in the lateral direction is preferably greater than one half of the width of the image region G100 in the lateral direction.

The display controller 304 causes the display image generated by the image generator 303 to be displayed. As a result, the display image is projected onto the windshield 21 of the vehicle 20, and the user (e.g., a driver or a passenger) can view display object information displayed by the display image as a virtual image.

Also, in a region different from (or other than) the region G110 in the image region G100, the virtual image may be geometrically converted such that the viewer (user) can feel the depth of the virtual image on a road surface that is in the field of view of the viewer. This enables the user to view a virtual image with a depth feel in a region other than the region G110. The geometric conversion is performed by generating a geometrically-converted display image with the image generator 303 and by drawing the geometrically-converted display image with the display controller 304. That is, the image generator 303 generates image data such that display items corresponding to objects, which are outside of the vehicle 20 and visible by the user, are dynamically displayed and changed depending on the positional relationship between the objects and the vehicle 20.

Examples of the display items corresponding to the objects include markings on a centerline, a curb, a leading vehicle, and a pedestrian on a sidewalk. In this case, the image generator 303 may be configured to prioritize multiple display items (e.g., markings) in order of necessity of attention and generate image data such that the user can recognize the differences in priority levels between the display items. For example, the differences in priority levels may be indicated by colors, brightness levels, shapes, sizes, and/or positions of the display information items. More specifically, a display item representing a centerline set at the highest priority level may be displayed in red, a display item representing a curb set at the second highest priority level may be displayed in yellow, and a display item representing a leading vehicle set at the third highest priority level may be displayed in green. That is, a display item (e.g., a marking) with a higher priority level in necessity of attention may be displayed in a more noticeable color.

<Process>

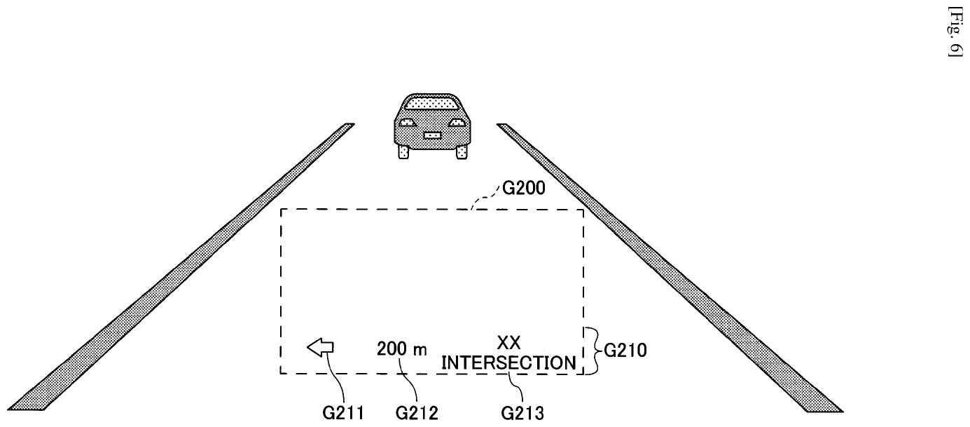

Next, a process performed by the display apparatus 10 of the present embodiment is described. FIG. 5 is a flowchart illustrating a process performed by the display apparatus according to the first embodiment. In the process described below, the display apparatus 10 displays a display image while navigation to a destination is being performed by the vehicle navigation apparatus 40 in the moving vehicle 20.

First, the vehicle information acquirer 301 obtains vehicle information (step S101). As described above, the vehicle information acquirer 301 may obtain vehicle information from the ECU 50 of the vehicle 20 via the I/F 205. However, if display object information based on vehicle information is not to be generated in later step S103, the vehicle information acquirer 301 does not have to obtain the vehicle information.

Next, the navigation information acquirer 302 obtains navigation information (step S102). As described above, the navigation information acquirer 302 may obtain navigation information, via the I/F 205, from the vehicle navigation apparatus 40 on the vehicle 20 or from an information processing terminal including a navigation function. However, if display object information based on navigation information is not to be generated in later step S103, the navigation information acquirer 302 does not have to obtain the navigation information.

Next, the image generator 303 generates one or more sets of display object information based on at least one of the vehicle information obtained by the vehicle information acquirer 301 and the navigation information obtained by the navigation information acquirer 302. Then, the image generator 303 generates a display image for displaying the display object information (step S103). At this step, the image generator 303 generates the display image such that the display object information is displayed in a predetermined region in an image region of the display image.

Information items in the vehicle information and the navigation information used to generate display object information may be freely set by, for example, the user of the display apparatus 10. For example, the user may operate the display apparatus 10 while the vehicle 20 is not moving and select items (e.g., “speed of vehicle”, “speed limit of currently-traveling road”, “distance to next guidance point”, “travel direction at next guidance point”, and “name of next guidance point”) to be displayed as display object information. The image generator 303 generates display object information based on information (vehicle information and/or navigation information) corresponding to the items selected by the user and generates a display image for displaying the display object information.

The display controller 304 displays the display image generated by the image generator 303 (step S104). That is, the display controller 304 projects the display image generated by the image generator 303 onto the windshield 21 of the vehicle 20 and thereby displays the display image.

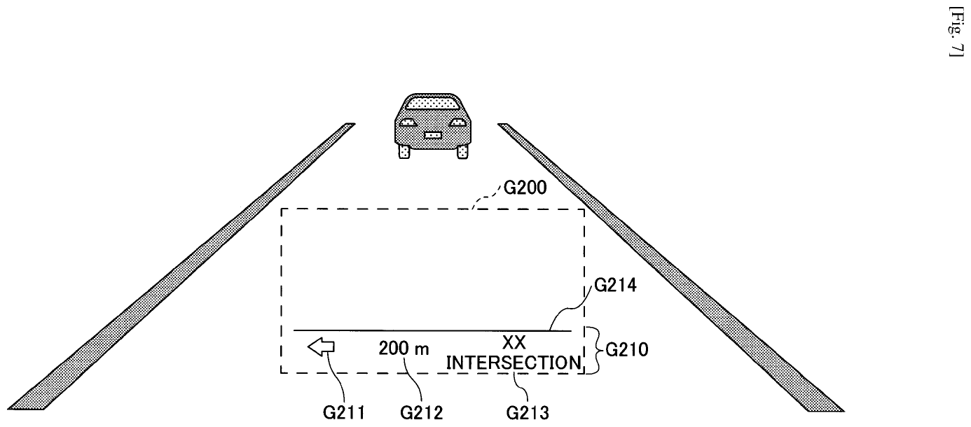

FIG. 6 is a drawing illustrating an example where the display image is projected onto the windshield 21 by the display controller 304 such that the user can view the display image. In the example of FIG. 6, display object information G211, display object information G212, and display object information G213 are displayed in a lower-end region G210 in an image region G200 of the display image.

The display object information G211 is an object indicating that the travel direction at the next guidance point is the left-hand direction. The display object information G212 is an object indicating a distance to the next guidance point. The display object information G213 is an object indicating the name of the next guidance point. These information items “travel direction at next guidance point”, “distance to next guidance point”, and “name of next guidance point” can be obtained from the navigation information.

Thus, the display object information G211, the display object information G212, and the display object information G213 are displayed in the lower-end region G210, i.e., near the peripheral visual field of the user. This configuration makes it possible to prevent the display object information G211, the display object information G212, and the display object information G213 from entering the field of view of the user while driving the vehicle 20, and makes it possible to prevent the display object information from bothering the user.

Thus, because the display object information G211, the display object information G212, and the display object information G213 are displayed together in the lower-end region G210 (e.g., arranged along a horizontal line), the user can easily view a desired one of the display object information G211, the display object information G212, and the display object information G213. This makes it possible to prevent the user from being bothered in finding desired display object information. Also, this makes it possible to reduce time taken to move the line of sight to find desired display object information and thereby improve the safety in driving the vehicle 20.

In the example of FIG. 6, the display object information G211, the display object information G212, and the display object information G213 are displayed in a line in the lower-end region G210. However, the present invention is not limited to this example, and the display object information G211, the display object information G212, and the display object information G213 may be displayed in multiple lines. Also, the number of sets of display object information displayed in the lower-end region G210 is not limited to three as in FIG. 6, and any number of sets of display object information may be displayed in the lower-end region G210.

Further, display object information may also be displayed in a region other than the lower-end region in the image region of the display image. For example, display object information may be displayed in an upper-end region, a right-end region, or a left-end region in the image region of the display image. However, an area where display object information is displayed is preferably positioned lower than the center of the image region in the vertical direction, and is more preferably positioned at the lower end of the image region.

FIG. 7 is a drawing illustrating an example where the display image is projected onto the windshield 21 by the display controller 304 such that the user can view the display image. In the example of FIG. 7, a line G214 is displayed in addition to the display object information G211-G213. The line G214 functions as a marker indicating a region where display object information is displayed, and makes it possible to reduce the distance that the user moves the line of sight to view the display object information G211, the display object information G212, and the display object information G213. Thus, displaying the line G214 can further reduce botheration felt by the user.

Steps S101 through S104 described above may be repeated, for example, at predetermined time intervals. However, steps S103 and S104 may be repeated only when vehicle information and navigation information obtained at steps S101 and S102 in the current cycle are different from the vehicle information and the navigation information obtained at steps S101 and S102 in the immediately preceding cycle.

### Second Embodiment

A second embodiment is described below. With the related-art technologies, a user (e.g., a driver or a passenger) may feel bothered because the position of information displayed in an image region of a display image is fixed.

For example, if the position of information indicating a travel direction at the next guidance point is fixed at a left-side position in the image region and the information indicates a right turn as the travel direction, the direction of the line of sight of the user becomes different from the travel direction. This necessitates the user to move the line of sight a long distance and causes the user to feel bothered.

The second embodiment is directed to solving such botheration. Below, differences of the second embodiment from the first embodiment are mainly described, and descriptions of components that are the same as those in the first embodiment may be omitted.

<Functional Configuration>

The functional configuration of the display apparatus 10 of the second embodiment is substantially the same as the functional configuration of the display apparatus 10 of the first embodiment. In the second embodiment, however, the image generator 303 generates a display image such that display object information is displayed in a predetermined position in an image region of a the display image according to the type of the display object information.

Also in the second embodiment, the image generator 303 generates a display image such that display object information is displayed in a position that corresponds to a direction indicated by the display object information. For example, if the display object information indicates that “the travel direction at the next guidance point is the right-hand direction”, the image generator 303 generates the display image such that the display object information is displayed in a right-side position in the image region of the display image (a position that is shifted to the right from the center of the image region in the lateral direction). On the other hand, if the display object information indicates that “the travel direction at the next guidance point is the left-hand direction”, the image generator 303 generates the display image such that the display object information is displayed in a left-side position in the image region of the display image (a position that is shifted to the left from the center of the image region in the lateral direction).

Displaying the display object information in a position corresponding to the direction indicated by the display object information makes it possible to reduce the distance that the user needs to move the line of sight to look in that direction after viewing the display object information. This in turn makes it possible to prevent the user from being bothered by having to move the line of sight a long distance during driving.

<Process>

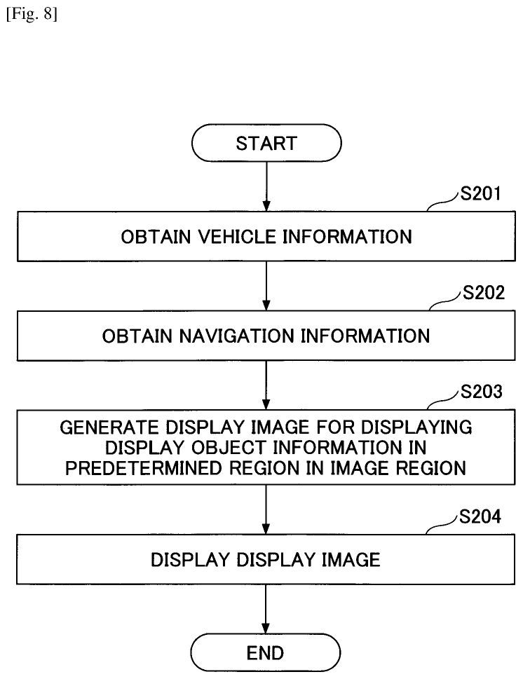

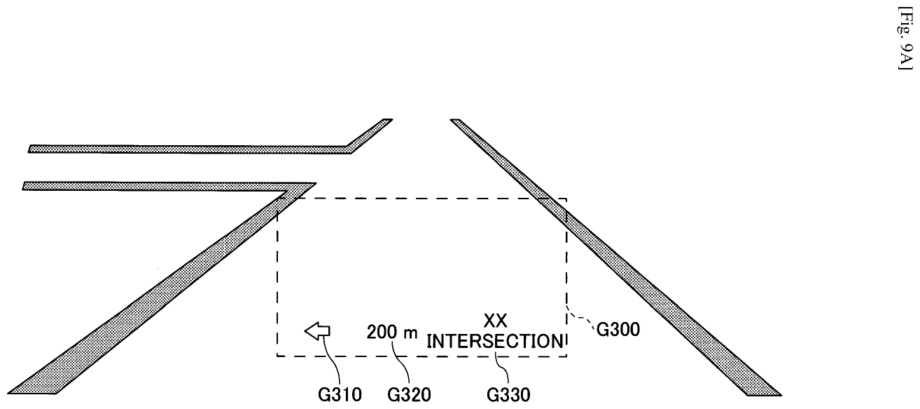

Next, a process performed by the display apparatus 10 of the second embodiment is described with reference to FIG. 8. FIG. 8 is a flowchart illustrating a process performed by the display apparatus 10 according to the second embodiment. In the process described below, the display apparatus 10 displays a display image while navigation to a destination is being performed by the vehicle navigation apparatus 40 in the moving vehicle 20. Steps S201 and S202 of FIG. 8 are substantially the same as steps S101 and S102 of FIG. 5, and therefore their descriptions are omitted here.

After step S202, the image generator 303 generates one or more sets of display object information based on at least one of the vehicle information obtained by the vehicle information acquirer 301 and the navigation information obtained by the navigation information acquirer 302. Then, the image generator 303 generates a display image for displaying the display object information (step S203). At this step, the image generator 303 generates the display image such that the display object information is displayed in a predetermined position in the image region of the display image according to the type of the display object information (e.g., if the display object information indicates a direction, the display object information is displayed in a position corresponding to the direction).

As described above, information items in the vehicle information and the navigation information used to generate display object information may be freely set by, for example, the user of the display apparatus 10. For example, the user may operate the display apparatus 10 while the vehicle 20 is not moving and select items (e.g., “speed of vehicle”, “speed limit of currently-traveling road”, “distance to next guidance point”, “travel direction at next guidance point”, and “name of next guidance point”) to be displayed as display object information. The image generator 303 generates display object information based on information (vehicle information and/or navigation information) corresponding to the items selected by the user and generates a display image for displaying the display object information.

Next, the display controller 304 displays the display image generated by the image generator 303 (step S204). That is, the display controller 304 forms an optical image based on image data generated by the image generator 303 and projects the optical image onto the windshield 21 of the vehicle 20 to display the display image.

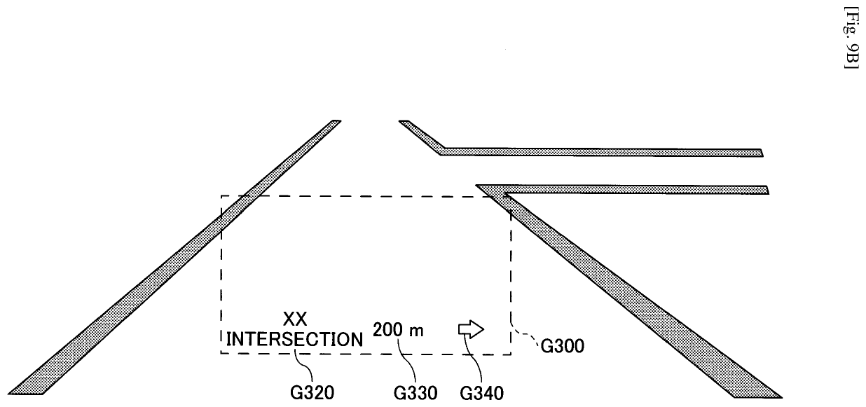

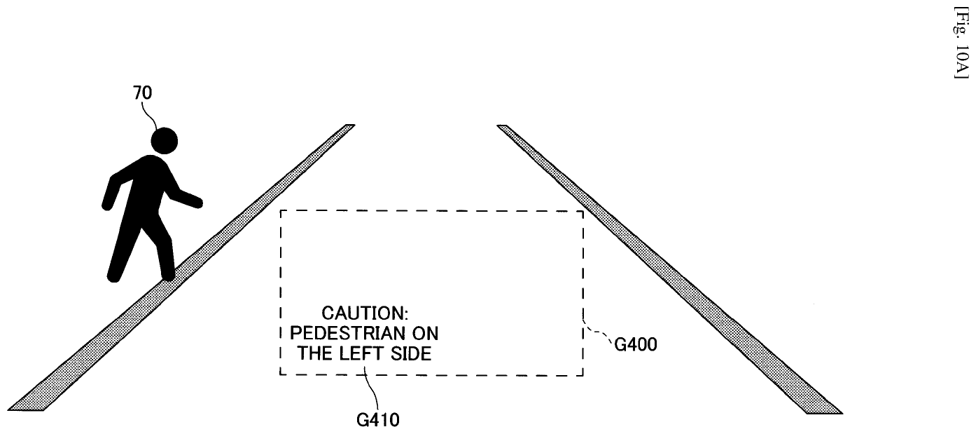

FIGS. 9A and 9B are drawings illustrating examples where the display image is projected onto the windshield 21 by the display controller 304 such that the user can view the display image.

In the example of FIG. 9A, display object information G310, display object information G320, and display object information G330 are displayed in an image region G300 of the display image.

The display object information G310 is an object indicating that the travel direction at the next guidance point is the left-hand direction. The display object information G320 is an object indicating a distance to the next guidance point. The display object information G330 is an object indicating the name of the next guidance point. These information items “travel direction at next guidance point”, “distance to next guidance point”, and “name of next guidance point” can be obtained from the navigation information.

In the second embodiment, the image generator 303 places the display object information G310, which indicates that the travel direction at the next guidance point is the left-hand direction, in a left-side position (the lower-left position in the example of FIG. 9A) in the image region G300. The display object information G320 and the display object information G330 are positioned to the right of the display object information G310.

In the example of FIG. 9B, display object information G320, display object information G330, and display object information G340 are displayed in the image region G300 of the display image. The display object information G340 is an object indicating that the travel direction at the next guidance point is the right-hand direction.

In the second embodiment, the image generator 303 places the display object information G340, which indicates that the travel direction at the next guidance point is the right-hand direction, in a right-side position (the lower-right position in the example of FIG. 9B) in the image region G300. The display object information G320 and the display object information G330 are positioned to the left of the display object information G340.

In the second embodiment, as illustrated in FIGS. 9A and 9B, display object information indicating a travel direction of the vehicle 20 at the next guidance point is displayed in a position corresponding to the travel direction in the image region G300. This configuration makes it possible to reduce the distance that the user needs to move the line of sight to look in the travel direction after viewing the display object information. This in turn makes it possible to prevent the user from being bothered by having to move the line of sight a long distance after viewing displayed information.

As illustrated in FIGS. 9A and 9B, in the image region G300, the display object information G310 indicating the left-hand direction and the display object information G340 indicating the right-hand direction are displayed in positions that are arranged along the lateral direction. With this configuration, the user can easily find desired display object information by looking at a predetermined region extending in the lateral direction of the image region G300. This makes it possible to prevent the user from being bothered in finding desired display object information. Also, this makes it possible to reduce time taken to move the line of sight to find desired display object information and thereby improve the safety in driving the vehicle 20.

In the example of FIG. 9A, the display object information G310, which indicates that the travel direction at the next guidance point is the left-hand direction, is placed in a lower-left position. However, the present invention is not limited to this example, and the display object information G310 may be displayed in an upper-left position. Also, the display object information G310 may be displayed in a left-side position near the center in the height direction of the image region G300. The display object information G310 may not necessarily be displayed to the left of the center of the image region G300 as long as the display object information G310 is displayed to the left of the display object information G340 indicating that the travel direction is the right-hand direction.

Similarly, in the example of FIG. 9B, the display object information G340, which indicates that the travel direction at the next guidance point is the right-hand direction, is placed in a lower-right position. However, the present invention is not limited to this example, and the display object information G340 may be displayed in an upper-right position. Also, the display object information G340 may be displayed in a right-side position near the center in the height direction of the image region G300. The display object information G340 may not necessarily be displayed to the right of the center of the image region G300 as long as the display object information G340 is displayed to the right of the display object information G310 indicating that the travel direction is the left-hand direction.

In FIG. 9A, the image region G300 is wider than the display region of the display object information G310, the display object information G320, and the display object information G330. However, the image region G300 may be a horizontally-long region corresponding to the size of the display region of the display object information G310, the display object information G320, and the display object information G330. The same applies to FIG. 9B.

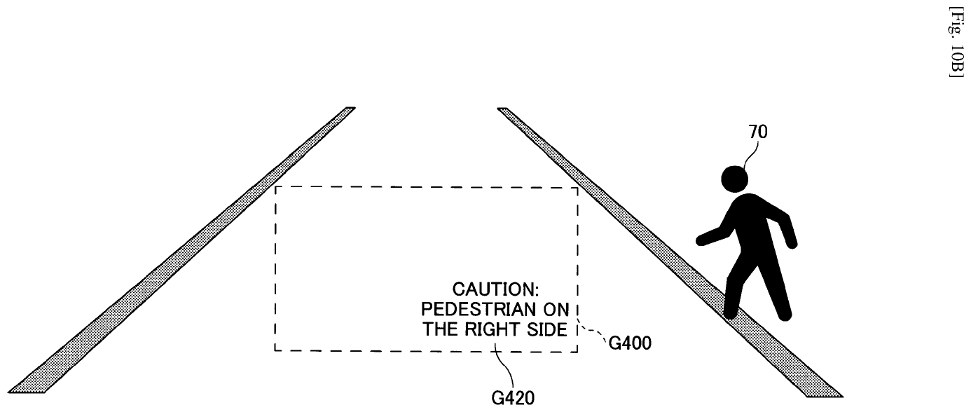

In FIGS. 9A and 9B, display object information indicating a travel direction at the next guidance point is displayed in a position corresponding to the travel direction at the next guidance point. FIGS. 10A and 10B are drawings illustrating examples of display object information calling attention to pedestrians to the left and right of the vehicle 20.

In the example of FIG. 10A, display object information G410 is displayed in an image region G400 of the display image. The display object information G410 is an object that calls attention to a pedestrian 70 to the left of the vehicle 20.

In this case, the image generator 303 places the display object information G410, which calls attention to the pedestrian 70 to the left of the vehicle 20, in a left-side position (the lower-left position in the example of FIG. 10A) in the image region G400.

In the example of FIG. 10B, display object information G420 is displayed in the image region G400 of the display image. The display object information G420 is an object that calls attention to a pedestrian 70 to the right of the vehicle 20.

In this case, the image generator 303 places the display object information G420, which calls attention to the pedestrian 70 to the right of the vehicle 20, in a right-side position (the lower-right position in the example of FIG. 10B) in the image region G400.

As illustrated in FIGS. 10A and 10B, display object information calling attention to the pedestrian 70 is displayed on a side of the image region G400 that corresponds to the direction in which the pedestrian 70 exists. This configuration makes it possible to reduce the distance that the user needs to move the line of sight to look at the pedestrian 70 after viewing the display object information. This in turn makes it possible to prevent the user from being bothered by having to move the line of sight after viewing displayed information, enable the user to quickly view the pedestrian 70, and thereby improve the safety in driving.

Also, as illustrated in FIGS. 10A and 10B, in the image region G400, the display object information G410 calling attention to the pedestrian 70 on the left side and the display object information G420 calling attention to the pedestrian 70 on the right side are displayed in positions that are arranged along the lateral direction. With this configuration, the user can easily find desired display object information by looking at a predetermined region extending in the lateral direction of the image region G400. This makes it possible to prevent the user from being bothered in finding desired display object information. Also, this makes it possible to reduce time taken to move the line of sight to find desired display object information and thereby improve the safety in driving the vehicle 20.

In the example of FIG. 10A, the display object information G410, which calls attention to the pedestrian 70 to the left of the vehicle 20, is placed in a lower-left position. However, the present invention is not limited to this example, and the display object information G410 may be displayed in an upper-left position. Also, the display object information G410 may be displayed in a left-side position near the center in the height direction of the image region G400. The display object information G410 may not necessarily be displayed to the left of the center of the image region G400 as long as the display object information G410 is displayed to the left of the display object information G420 calling attention to the pedestrian 70 on the right side.

In the example of FIG. 10B, the display object information G420, which calls attention to the pedestrian 70 to the right of the vehicle 20, is placed in a lower-right position. However, the present invention is not limited to this example, and the display object information G420 may be displayed in an upper-right position. Also, the display object information G420 may be displayed in a right-side position near the center in the height direction of the image region G400. The display object information G420 may not necessarily be displayed to the right of the center of the image region G400 as long as the display object information G420 is displayed to the right of the display object information G410 calling attention to the pedestrian 70 on the left side.

In FIGS. 10A and 10B, the image region G400 is wider than the display region of the display object information G410 and the display object information G420. However, the image region G400 may be a horizontally-long region corresponding to the size of the display region of the display object information G410 and the display object information G420.

In FIGS. 10A and 10B, each of the display object information G410 and the display object information G420 calls attention to the pedestrian 70 to the left or the right of the vehicle 20. However, display object information may also be used to call attention to other vehicles or traffic lanes. For example, display object information may call attention to another running vehicle on the left or right side of the vehicle 20 or may be used to warn the driver to prevent the vehicle 20 form drifting out of the lane in the right or left direction. Thus, display object information may be used to call attention to various objects (attention targets) such as the pedestrian 70, other vehicles, and traffic lanes around the vehicle 20.

Steps S201 through S204 described above may be repeated, for example, at predetermined time intervals. However, steps S203 and S204 may be repeated only when vehicle information and navigation information obtained at steps S201 and S202 in the current cycle are different from the vehicle information and the navigation information obtained at steps S201 and S202 in the immediately preceding cycle.

### SUMMARY

As described above, the display apparatus 10 of the first embodiment displays a display image where various types of display object information are displayed in a line at a lower position in the image region of the display image. This configuration makes it possible to prevent the display object information from bothering the user while driving and enables the user to easily identify desired object information. Thus, the display apparatus 10 of the first embodiment makes it possible to prevent display object information from bothering the user.

Accordingly, the display apparatus 10 of the first embodiment enables the driver of the vehicle 20 to focus on driving and easily obtain information necessary for the driving, and thereby makes it possible to improve the safety in driving.

Also, the display apparatus 10 of the second embodiment displays a display image such that display object information indicating a travel direction or an attention-called direction to which attention is called is displayed in a position corresponding to the travel direction or the attention-called direction. This configuration makes it possible to reduce the distance that the user needs to move the line of sight to look in the travel direction or the attention-called direction after viewing the display object information. Thus, the display apparatus 10 of the second embodiment also makes it possible to prevent display object information from bothering the user.

Accordingly, the display apparatus 10 of the second embodiment enables the driver of the vehicle 20 to take into account display object information in driving the vehicle 20 immediately after obtaining the display object information, and thereby makes it possible to improve the safety in driving.

Also, the display apparatus 10 of the second embodiment displays display object information indicating a travel direction and display object information indicating a direction to which attention is called in positions that are arranged along the lateral direction. With this configuration, the user can easily find desired display object information by looking at a predetermined region extending in the lateral direction of the image region G400. This makes it possible to prevent the user from being bothered in finding desired display object information. Also, this makes it possible to reduce time taken to move the line of sight to find desired display object information and thereby improve the safety in driving the vehicle 20.

An image control apparatus, a display apparatus, a mobile body, an image data generation method, and a program according to embodiments of the present invention are described above. However, the present invention is not limited to the specifically disclosed embodiments, and variations and modifications may be made without departing from the scope of the present invention. For example, at least one of the functional units of the display apparatus 10 may be implemented by cloud computing employing one or more computers.

The present application is based on and claims the benefit of priority of Japanese Priority Application No. 2018-062094 filed on Mar. 28, 2018, Japanese Priority Application No. 2018-062096 filed on Mar. 28, 2018, and Japanese Priority Application No. 2019-052964 filed on Mar. 20, 2019, the entire contents of which are hereby incorporated herein by reference.

### REFERENCE SIGNS LIST

10 Display apparatus
20 Vehicle
21 Windshield
301 Vehicle information acquirer
302 Navigation information acquirer
303 Image generator
304 Display controller

1. An image control apparatus, comprising:
an image generator that generates image data for displaying information indicating a direction or a position in a display region on a mobile body, wherein
the image generator generates the image data such that, from a viewpoint of an occupant of the mobile body, information indicating a left-hand direction or a left-side position is displayed to a left of information indicating a right-hand direction or a right-side position; and
a position where the information indicating the left-hand direction or the left-side position is displayed and a position where the information indicating the right-hand direction or the right-side position is displayed are arranged along a lateral direction of the display region.

2. The image control apparatus as claimed in claim 1, wherein when the image generator generates the image data based on navigation information, the information indicating the direction or the position indicates a travel direction at a next guidance point.

3. The image control apparatus as claimed in claim 2, wherein
when the travel direction at the next guidance point is a right-hand direction, the image generator generates the image data such that the information indicating the travel direction is displayed on a right side of a predetermined region; and
when the travel direction at the next guidance point is a left-hand direction, the image generator generates the image data such that the information indicating the travel direction is displayed on a left side of the predetermined region.

4. The image control apparatus as claimed in claim 3, wherein the image generator generates the image data that displays at least the information indicating the travel direction, information indicating the next guidance point, and information indicating a distance to the next guidance point in a line.

5. The image control apparatus as claimed in claim 1, wherein when the image generator generates information indicating an attention target around the mobile body, the information indicating the direction or the position is information indicating a position of the attention target.

6. The image control apparatus as claimed in claim 5, wherein
when the attention target is located on a right side with respect to a travel direction of the mobile body, the image generator generates the image data such that the information indicating the position of the attention target is displayed on a right side of a predetermined region; and
when the attention target is located on a left side with respect to the travel direction of the mobile body, the image generator generates the image data such that the information indicating the position of the attention target is displayed on a left side of the predetermined region.

7. The image control apparatus as claimed in claim 3, wherein an area of the predetermined region is less than one half of an area of the display region.

8. The image control apparatus as claimed in claim 7, wherein a height of the predetermined region in a vertical direction is less than one half of a height of the display region in the vertical direction, and a width of the predetermined region in a lateral direction is greater than one half of a width of the display region in the lateral direction.

9. The image control apparatus as claimed in claim 7, wherein the predetermined region is disposed in a lower half of the display region.

10. The image control apparatus as claimed in claim 7, wherein the image generator generates the image data such that a display item corresponding to an object that is outside of the mobile body and visible by the occupant is dynamically displayed and changed, in a region of the display region different from the predetermined region, depending on a positional relationship between the object and the mobile body.

11. The image control apparatus as claimed in claim 1, further comprising:
a receiver that receives information input from a navigation apparatus and information input from a controller of the mobile body.

12. A display apparatus, comprising:
the image control apparatus as claimed in claim 1; and
a projector that projects an optical image generated based on the image data generated by the image control apparatus onto a transmissive reflector of the mobile body.

13. A mobile body, comprising:
a navigation apparatus; and
the display apparatus as claimed in claim 12.

14. A method performed by an image control apparatus, the method comprising:
generating image data for displaying information indicating a direction or a position in a display region on a mobile body, wherein
the image data is generated such that, from a viewpoint of an occupant of the mobile body, information indicating a left-hand direction or a left-side position is displayed to a left of information indicating a right-hand direction or a right-side position; and
a position where the information indicating the left-hand direction or the left-side position is displayed and a position where the information indicating the right-hand direction or the right-side position is displayed are arranged along a lateral direction of the display region.

15. A non-transitory computer-readable recording medium storing a program that causes a computer to execute a process, the process comprising:
generating image data for displaying information indicating a direction or a position in a display region on a mobile body, wherein
the image data is generated such that, from a viewpoint of an occupant of the mobile body, information indicating a left-hand direction or a left-side position is displayed to a left of information indicating a right-hand direction or a right-side position; and
a position where the information indicating the left-hand direction or the left-side position is displayed and a position where the information indicating the right-hand direction or the right-side position is displayed are arranged along a lateral direction of the display region.
